(19) United States
(12) Patent Application Publication
(10) Pub. No.: US 2017/0109820 A1
(43) Pub. Date: Apr. 20, 2017

(54) SLICER ANALYZER TOOL

(71) Applicant: TRADING TECHNOLOGIES INTERNATIONAL INC., CHICAGO, IL (US)

(72) Inventors: William Tigard BAKER, Hoffman Estates, IL (US); Gerald J. O'CONNOR, Wilmette, IL (US); Scott F. SINGER, Green Oaks, IL (US)

(21) Appl. No.: 14/885,456

(22) Filed: Oct. 16, 2015

(51) Int. Cl. G06Q 40/04; G06T 11/60

(52) U.S. Cl. CPC G06Q 40/04; G06T 11/60

(57) ABSTRACT

Slicer orders may be simulated by applying slicer information to historical market data. The slicer information may include order parameters that define the slicer order. The order parameters in the slicer information may be applied to the historical market data by identifying times and prices at which child orders may be placed, filled, and/or changed in the market data according to the defined parameters. Slicer order information and/or slicer performance information may be displayed to indicate the effects of changes to different order parameters on the performance of a slicer order in the market. The slicer order information may include order indicia that may indicate information related to one or more child orders that may be placed based on orders in the market data. The slicer performance information may be displayed to indicate the performance of defined slicer orders that are applied to a market.

### BACKGROUND

An electronic trading system generally includes a trading device in communication with an electronic exchange. The trading device receives market data, such as prices and quantities, from the electronic exchange and displays the market data to a user. The trading device may allow the user to perform searches to identify tradeable objects for which market data may be displayed to a user.

A slicer order is a synthetic strategy that involves breaking or slicing one order into multiple component orders that are traded separately. For example, a parent order may be time slicer and/or volume slicer into one or more child orders. Slicer orders may be utilized to, for example, reduce a market impact when a total desired quantity of an order is large relative to market liquidity.

Users of trading devices may have difficulty analyzing and predicting how slicer orders (e.g., volume slicer orders and/or time slicer orders) will behave or would have behaved in a given market. Users of trading devices may replay saved data or run simulations, but these techniques are time consuming, produce unreliable results, and fail to provide the users with the proper information for determining how to slice orders to take advantage of a market.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIGS. 4A-4C illustrate examples of a user interface that may be generated and displayed at a trading device to communicate slicer order information and/or slicer performance information to a user of the trading device.

FIG. 5A illustrates an example of slicer performance information depicting a traded average with respect to a benchmark for a single day.

FIG. 5B illustrates an example of slicer performance information depicting a normalized traded average with respect to the benchmark for multiple days.

FIG. 5C illustrates another example of slicer performance information depicting multiple days of the traded average with respect to the benchmark.

FIG. 6 illustrates a block diagram representative of an example system in which certain embodiments may be employed.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Slicer orders have component parts (referred to herein as child orders) that are separately sent to one or more markets to collectively buy or sell a total quantity of a tradeable object. To implement a slicer order, a trading device may send at least one of the child orders to one or more markets in response to, for example, an event or condition defined in the slicer order, such as an amount of time elapsing or a volume of activity occurring at the market(s). After an initiation or activation of the slicer order, the trading device may send the child orders, when triggered, to the market(s) to collectively buy or sell the total quantity of the parent slicer order.

There are different types of slicer orders. The slicer orders may include time slicer orders and volume slicer orders. Depending on a type of slicer order, each child order is triggered (for example, sent to a market or an exchange) by one or more events or conditions. For example, the child orders of a time slicer order may be sent to one or more markets when a respective time interval is reached. On the other hand, child orders of a volume slicer order can be sent to one or more markets when the market(s) experiences a designated trading volume. In such instances, one or more child orders of a volume slicer order are sent to the market(s) when the market(s) for which the child order(s) are destined have sufficient activity (as defined in order parameters associated with the volume slicer order, for example).

Slicer orders may be simulated by applying slicer information to historical market data. The slicer information may include order parameters that define the slicer order. The order parameters may include a start time of the slicer order, an order quantity for the slicer order, and/or an interval (e.g., a time interval or a volume interval) at which the child orders may be placed in the market. The order parameters in the slicer information may be applied to the historical market data by identifying times and prices at which child orders may be placed, filled, and/or changed in the market data according to the defined parameters.

The trading device may simulate defined slicer orders using historical market data and may display slicer order information and/or slicer performance information to help the user better understand the effects of changes to different order parameters on the performance of a slicer order in the market. The trading device may also, or alternatively, generate slicer order information and/or slicer performance information using real-time market data to track a slicer order in the actual market to help the user adjust different order parameters to change the performance of a slicer order in the market.

The slicer order information may include order indicia that may indicate information related to one or more child orders that may be placed based on orders in the market data. The order indicia may be overlaid on an image of the displayed market data. The order indicia may indicate the time and/or the price at which each of the child orders may be placed, filled, or changed when the order parameters in the slicer information are applied to the market data. The order indicia may also, or alternatively, indicate a pricing path that shows the price of the child orders over one or more time intervals.

The slicer performance information may include an average fill price for each for the parent order and for each of the child orders. The slicer performance information may also include an amount of time until the order quantity associated with the parent slicer order is fully filled in the market data. The slicer performance information may include other information that may be displayed to indicate the performance of order parameters for slicer orders that are applied to market data.

A trading device may generate and display slicer order information and/or slicer order performance information to assist a user in better understanding the effect of certain order parameters on slicer orders in the market. Users may use the slicer order information and/or slicer order performance information to predict how slicer orders having certain parameters may behave in certain markets and users may submit updated slicer orders that include different order parameters for defining the slicer orders based on the slicer order information and/or slicer order performance information.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Systems, methods, and apparatus are described for generating and displaying slicer order information and/or slicer order performance information. As described herein, market data may be received that is related to at least one tradeable object from an electronic exchange. The market data may include historical market data that is retrieved from a historical market datastore or real-time market data from the electronic exchange. The market data may be displayed in an image. Slicer information may be received that includes parameters for defining a parent slicer order. The slicer information may include a start time to begin slicing the parent slicer order for being matched within the market data, at least one interval at which the parent slicer order is slicer into a plurality of child orders for being matched within the market data, and/or an order quantity associated with the parent slicer order. The at least one interval may include a time interval or a volume interval.

The parent slicer order may be defined based on the received slicer information. The slicer information may be received by user selection of a location in the image. The parent slicer order may be applied to the received market data according to the slicer information. The parent slicer order may be applied by identifying in the market data a time and a price at which each of the plurality of child orders may be placed and/or filled.

Order indicia may be generated relative to the displayed market data. The order indicia may be overlaid on the image of the displayed market data. The order indicia may indicate at least one of the time or the price at which each of the plurality of child orders was placed when applied to the market data. The order indicia may indicate at least one of a time or a price at which each of the plurality of child orders was filled when applied to the market data. The order indicia may indicate at least one of a time or a price at which each of the plurality of child orders was changed when applied to the market data. The order indicia may indicate a pricing path that shows the price of the child orders over one or more time intervals.

Slicer performance information may be generated that indicates a performance of the defined parent slicer when applied to the market data. The slicer performance information may be displayed in a graph. The slicer performance information may include at least one of an average fill price for each of the plurality of child orders or an amount of time until the order quantity associated with the parent slicer order is fully filled in the market data.

The embodiments described herein may be performed by a slicer analysis manager that resides on one or more computing devices. For example, the slicer analysis manager may reside on a trading device. The trading device may comprise one or more computing devices, such as a trading terminal or trading terminals and a trading server(s). The slicer analysis manager may comprise software that may be distributed across the trading terminal and the trading server, or may reside at one of the trading terminal or the trading server. The software may be executed by a processor at the trading terminal or respective processors at the trading terminal and the trading server.

### II. Example Electronic Trading System

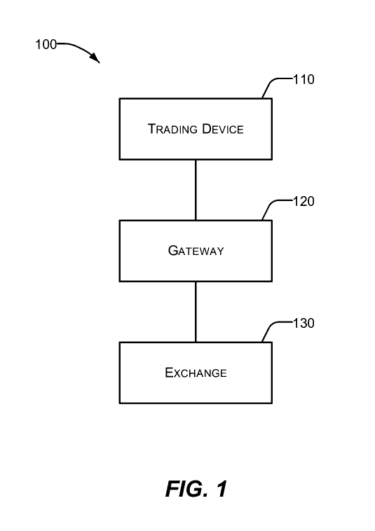

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

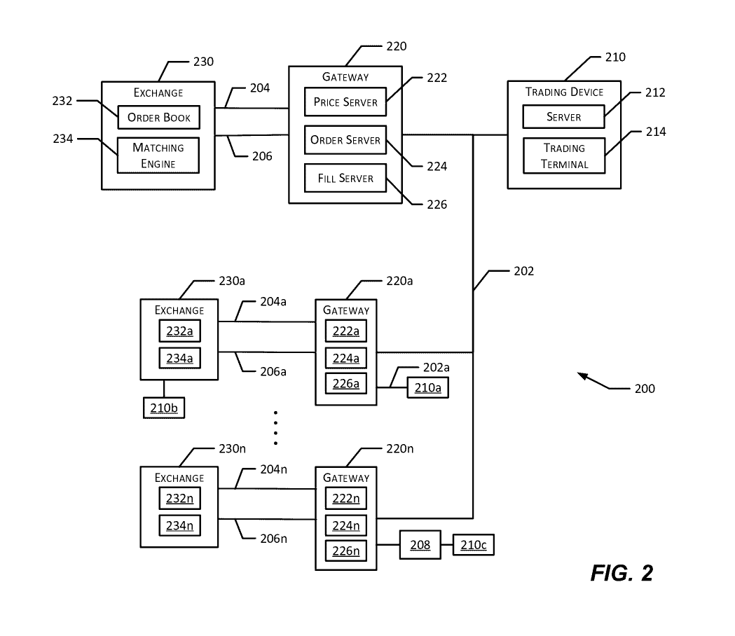

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each include instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

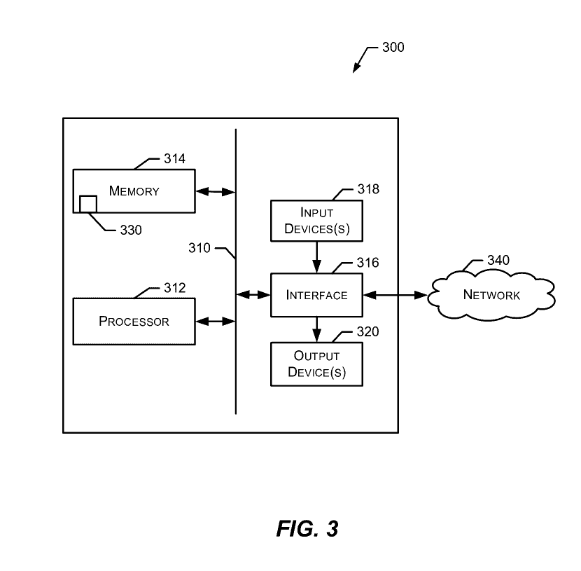

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Slicer Order Analysis

Slicer orders have component parts (referred to herein as child orders) that are separately sent to one or more markets to collectively buy or sell a total quantity of a tradeable object. To implement a slicer order, a trading device may send at least one of the related child orders to one or more markets in response to, for example, an event or condition defined in the slicer order, such as an amount of time elapsing or a volume of activity occurring at the market(s). After an initiation or activation of the slicer order, the trading device may send the child orders, when triggered, to the market(s) to collectively buy or sell the total quantity of the parent slicer order. The price and quantity of the child orders are specified based on parent order parameters such as the price, quantity, pay-up-ticks, variances, slop and other order variables. In addition to, or in lieu of, automatically sending child orders to the markets in response to triggers or detected events, the trading device may send child orders in response to direct user input. For example, the user may instruct the trading device to send a child order and the trading device may assist the user by, for example, tracking fill quantity and prices, insuring a sum of the child quantities does not exceed the parent slicer order quantity.

There are different types of slicer orders including, for example, time slicer orders and volume slicer orders. Depending on a type of slicer order, each child order is triggered (for example, sent to a market or an exchange) by one or more events or conditions. For example, the child orders of a time slicer order may be sent to one or more markets when a respective time interval is reached. In such instances, each time a clock reaches a time interval defined in the time slicer order as a trigger, a trading device sends one or more of the child orders to the market(s). For example, a time slicer order may be defined such that one of the child orders is sent every five minutes. On the other hand, child orders of a volume slicer order can be sent to one or more markets when the market(s) experience a designated trading volume. In such instances, one or more child orders of a volume slicer order are sent to the market(s) when the market(s) for which the child order(s) are destined have sufficient activity (as defined in order parameters associated with the volume slicer order, for example). For example, a volume slicer order may be defined such that one of the child orders is sent each time the destination market executes trade(s) for five hundred of the corresponding tradeable object.

A trading device may generate and display slicer order information and/or slicer order performance information to assist a user in better understanding the effect of certain order parameters on slicer orders in the market. For example, the trading device may simulate defined slicer orders using historical market data and display slicer order information and/or slicer performance information to help the user better understand the effects of changes to different order parameters on the performance of a slicer order in the market. The trading device may also, or alternatively, generate slicer order information and/or slicer performance information using real-time market data to track a slicer order in the actual market to help the user adjust different order parameters to change the performance of a slicer order in the market.

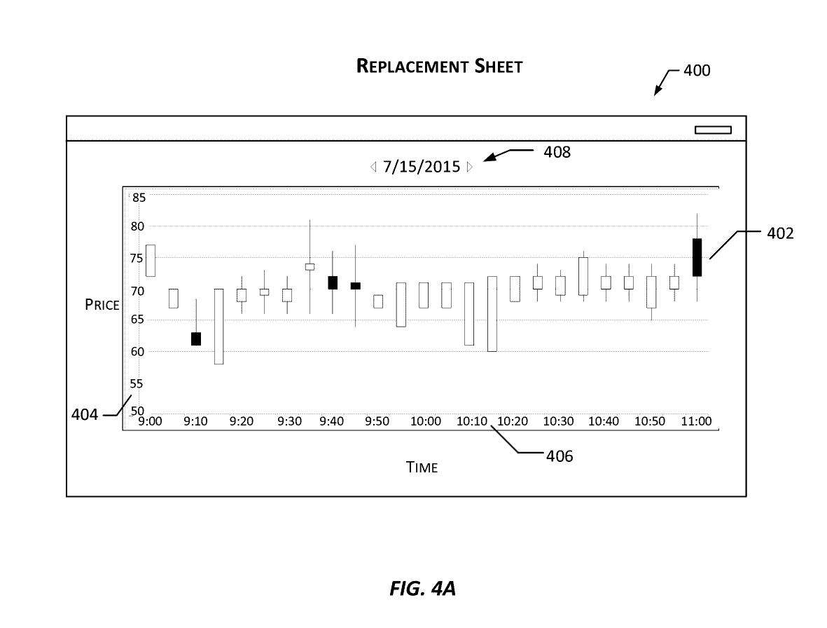

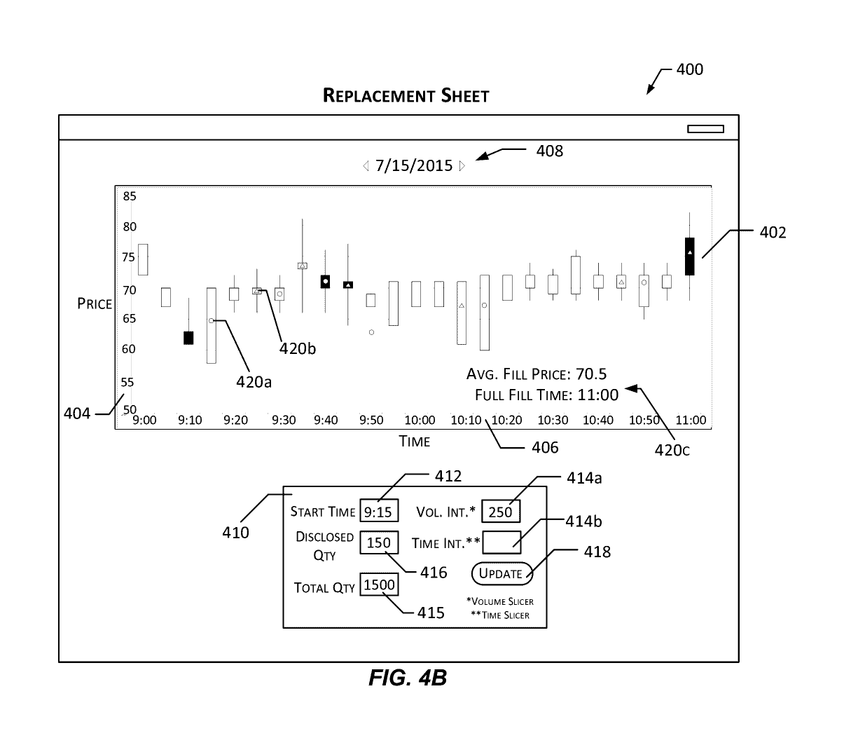

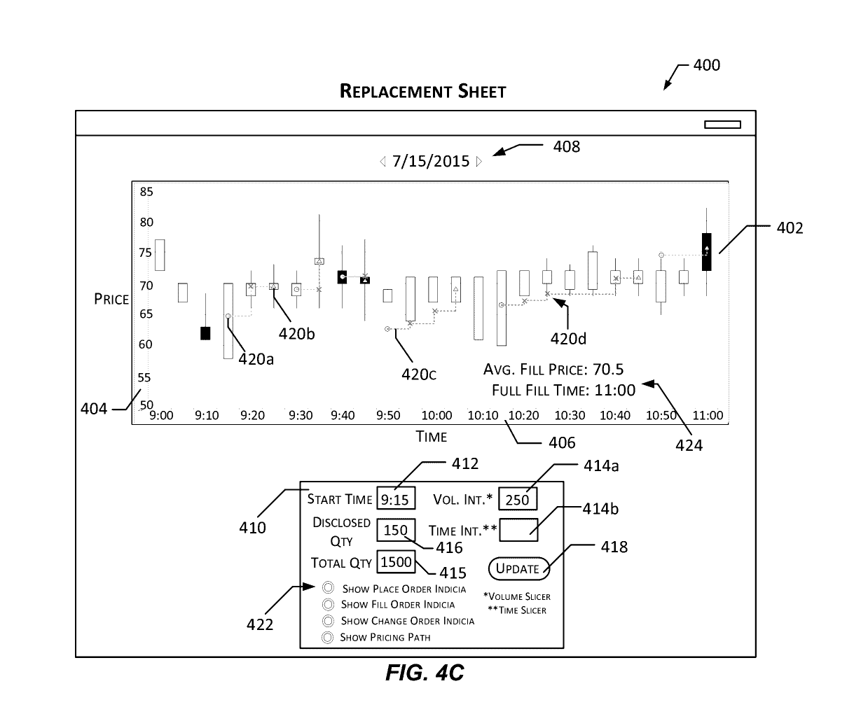

FIGS. 4A-4C illustrate examples of a user interface 400 that may be generated and displayed at a trading device, such as the trading device 110 of FIG. 1, to communicate slicer order information and/or slicer performance information to a user of the trading device. As shown in FIG. 4A, the interface 400 may include a bar graph 402 that includes a graphical representation of market data that indicates price information for trade orders that have been bought or sold in a market over different periods of time. The bar graph 402 may identify different price levels 404 and time intervals 406 over which the trade orders have been bought or sold on the market. Each bar in the bar graph is illustrated with a candlestick price bar that indicates price information, such as an opening price value, a high price value, a low price value, and/or a closing price value for a tradeable object over a predetermined period of time. As the exact values of each bar may be difficult to identify in the bar graph 402, the exact values of each bar may be displayed to the user upon selection (e.g., clicking or hovering over) of the bar.

The trading device may generate the bar graph 402 from market data received at the trading device. The bar graph 402 may be displayed as an image that is generated in response to historical market data or real-time market data received at the trading device. The historical market data may be displayed for a defined period of time 408. The period of time 408 may be selected by the user. Though the period of time 408 is shown in the interface 400 as being a date, the user may also, or alternatively, select the number of time intervals 406 over which the price information may be displayed in the bar graph 402. For example, the bar graph 402 shows twenty-five (25) five (5) minute intervals over a period of time from nine o'clock to eleven o'clock, but more or less time intervals may be displayed in the bar graph 402. The historical market data may be retrieved for the period of time 408 selected by the user and may be displayed in the bar graph 402. The historical market data may be retrieved locally from the trading device on which the user interface 400 is displayed or from a remote storage, such as an electronic exchange or a remote server, for example. The real-time market data may be received at the trading device from an electronic exchange in a market update message.

Users may use the market data displayed in the user interface 400 to analyze slicer orders. For example, the market data displayed in the user interface may be used to identify slicer order information and slicer performance information that may be used to predict how slicer orders may behave in the market. The trading device may receive slicer information from a user that may include order parameters for defining the slicer order. The order parameters may be used by the trading device to define a slicer order to be applied to the market data displayed in the user interface 400 and display order indicia that indicates performance of the slicer order when applied to the market data.

FIG. 4B illustrates an example of the user interface 400 that includes slicer order information that may be displayed when a slicer order is displayed as part of the bar graph 402. As shown in FIG. 4B, the trading device may collect slicer information from a user via the user interface 400. The slicer information may be collected from the slicer information input box 410. Though the slicer information input box is displayed apart from the bar graph 402 in the interface 400, the slicer information input box 410, or the slicer information therein, may be overlaid on the image of the bar graph 402 or provided in another interface altogether. The slicer information may include one or more parameters that may be used by the trading device to define a slicer order for being applied to the market data displayed in the bar graph 402. The trading device may apply the defined slicer order to the market data and may display order indicia, such as order indicia 420a, 420b for example, when the parameters of the slicer order are applied to the market data displayed in the bar graph 402.

The parameters of the slicer information that define a slicer order may include a start time 412 to begin slicing the parent slicer order for being matched within the market, an interval 414a, 414b at which the parent slicer order may be broken down into child orders for being matched within the market, a total order quantity 415 of the parent order and/or a disclosed order quantity 416 of the parent slicer order that may be sent into the market as a part of each of the child orders. In operation, the start time 412 associated with a time slicer order is the time at which a first child order of a parent slicer order is placed or sent to the market to be matched and filled. Similarly, the start time 412 associated with a volume slicer order indicates that the slicer order has started monitoring trading activity to determine with the volume interval has been reached. The volume interval 414a indicates a volume of the tradeable object to be matched in the market before submitting a child order to the market. For example, as shown in FIG. 4B, the trading device may place another child order when two hundred and fifty (250) units of the tradeable object are matched at the electronic exchange. The interval 414b is a time interval for defining a time slicer order. The time interval 414b indicates an amount between the placement of successive child orders to be matched within the market. The time interval 414b may include one or more intervals 406 shown in the bar graph 402. The volume interval 414a and the time interval 414b may be entered as distinct options for defining one of a volume slicer or a time slicer, respectively.

As shown in FIG. 4B, the slicer order parameters may be entered into text boxes in the slicer information input box 410. In certain embodiment, different and/or addition slicer order parameters may be displayed and accessible via the slicer information input box 410. For example, slicer order parameters such as those specifying the half-life action, leftover action, and end time may be displayed as part of the slicer information input box 410. One or more of the order parameters may also, or alternatively, be selected by other inputs. For example, the user may select the start time 412 on the image of the bar graph 402. The trading device may identify the location of the user selection within the image and may determine the start time 412 based on the relative location of the user selection to one of the time intervals 406. The trading device may set the start time 412 to the beginning of the time interval 406 that is closest to the user selection. The trading device may identify a user selection of a bar in the bar graph 402, a user selection of the time in one of the intervals 406, and/or a user selection of the area above one of the intervals 406 in the bar graph 402 and may use the start of the corresponding interval as the start time 412. The user may also, or alternatively, select the interval 414a, 414b and/or the order quantity 416 based on predefined values that may be displayed in the interface 400 (not shown). When the user wishes to define a time interval 414b, the user may identify the start time 412 and the end time for the first time interval 414b at which the next child order is to be placed within the market. The selected time interval the start time 412 may be used to define the time interval 414b and may be replicated for the other child orders of the same parent order.

The trading device may define a parent slicer order according to the parameters in the slicer information for being applied to the market data from which the image of the bar graph 402 is generated. The trading device may generate order indicia that indicate slicer order information related to the parent slicer order when the parameters in the slicer information are applied to the market. The parent slicer order may be applied to the market by placing each of the child orders in the market at each defined interval 414a, 414b indicated in the slicer information. The trading device may apply the parent slicer order to historical market data or market data received from an electronic exchange in real-time. When the parent slicer order is applied to historical market data, the trading device may simulate how the parent slicer order may behave relative to the historical market data identified in the bar graph 402. For example, the trading device may place the child orders and may identify contra-side trade orders in the historical market data that may be used to fill the child orders. When the parent slicer order is applied to real-time market data received from an electronic exchange, the trading device may submit the child orders to the electronic exchange and update the bar graph 402 according to market update messages received from the electronic exchange to reflect the current state of the market (e.g., including child orders that have been filled or changed at the electronic exchange).

The trading device may generate order indicia 420a, 420b relative to the market data displayed in the bar graph 402 to identify a time interval 406 and/or a price 404 at which the child orders may be placed and filled, respectively, according to the parameters in the slicer information. For example, the place order indicia 420a identifies a location at which the child orders is placed. The fill order indicia 420b may identify a location at which the child orders would be filled. The trading device may generate order indicia 420a, 420b by applying the parameters in the slicer information to the market data identified in the bar graph 402. The trading device may apply the parameters in the slicer information to the market data upon identifying a user selection of the button 418, for example. The order indicia 420a, 420b may be overlaid at a location on the image of the bar graph 402 to identify a price 404 and/or a time interval 406 at which the child orders may be placed and filled, respectively, when applied to the market data.

The order indicia 420a, 420b for the child orders may be generated and displayed differently for volume slicer orders and time slicer orders. The order indicia 420a, 420b shown in FIG. 4B illustrate order indicia 420a, 420b related to volume slicer orders. For volume slicer orders, the trading device may generate a place order indicator 420a for the first child order of a parent slicer order upon identifying the selection of the button 418 and may overlay the place order indicator 420a in a location on the bar graph 402 that includes the start time 412 to indicate the time interval 406 at which the first child order may be placed in the market. The place order indicator 420a may be overlaid on the bar graph 402 at, for example, an absolute price specified by the user or at a relative price defined with respect to a known price. For example, the relative price could be specified as an offset (e.g., a specified number of ticks) from a known price such as the best bid, best ask, and last traded price. The trading device may identify a quantity of trade orders in the market data that have been matched that is equal to or greater than the volume interval 414a before placing the next child order. For example, if the quantity of trade orders traded is greater than or equal to multiple intervals (e.g., if the quantity traded equals the quantity that would be traded over 3 intervals), then a single child order will be placed with a totally quantity that is multiplied by the number of intervals (i.e., the 3 intervals from the previous example). The trading device may continue to identify the volume interval 414a being matched in the market data and overlay place order indicia 420a until the order quantity 416 has been placed in the market.

The trading device may generate a fill order indicator 420b upon identifying a trade order in the market data that has an order quantity and price that match the order quantity and price of a previously placed child order and may overlay the fill order indicator 420b in a location on the bar graph that indicates the interval 406 and price 404, respectively, at which the previously placed child order may be filled. The trading device may continue to identify trade orders in the market data that have an order quantity and price that match the order quantity and price of a previously placed child order and overlay fill order indicia 420b until the order quantity 416 is fully filled. The trading device may store the time interval 406 and price 404 at which each child order is placed and filled for a volume slicer order.

Though FIG. 4B shows an example of how the trading device may generate and display the order indicia 420a, 420b for a volume slicer order, the trading device may similarly generate and display the order indicia 420a, 420b (as well as other order indicia herein) for time slicer orders. For time slicer orders, the trading device may generate a place order indicator 420a for the first child order of a parent slicer order upon identifying the selection of the button 418 and may overlay the place order indicator 420a in a location on the bar graph 402 that includes the start time 412 to indicate the time interval 406 at which the first child order would be placed in the market. The trading device may identify that the time interval 414b has passed before placing the next child order. The trading device may continue to identify that the time interval 414b has passed and overlay place order indicia 420a until the order quantity 416 has been placed in the market. If the market data is real-time market data received from the market, the trading device may actually submit an order to an electronic exchange when the time interval 414b and/or the volume interval 414a have passed.

The trading device may generate a fill order indicator 420b upon identifying a trade order in the market data that has an order quantity and price that match the order quantity and price of a previously placed child order and may overlay the fill order indicator 420b in a location on the bar graph that indicates the interval 406 and price 404, respectively, at which the previously placed child order may be filled. The trading device may continue to identify trade orders in the market data that have an order quantity and price that satisfy, or partially satisfy, the order quantity and price of a previously placed child order and overlay fill order indicia 420b until the total order quantity 416 is fully filled. The trading device may store the time interval 406 and price 404 at which each child order is placed and filled for a time slicer order. If the market data is real-time market data received from the market, the trading device may actually submit an order to an electronic exchange when the time interval 414b or the volume interval 414a have passed.

The order indicia 420a, 420b maybe overlaid on the bar graph 402 to indicate slicer order information when the parent slicer order is applied to the market data in the bar graph 402. The trading device may also generate and display other order indicia to indicate slicer order information when the parent slicer order is applied to the market data in the bar graph 402. As shown in FIG. 4C, the trading device may generate and display order indicia 420c and/or 420d, for example. Order indicia 420c may indicate a pricing path that shows the price of the placed child orders over one or more of the time intervals 406. The pricing path order indicia 420c may be displayed differently (e.g., in a different color, pattern, etc.) for buy orders and sell orders. The order indicia 420d may indicate a time interval 406 at which a price 404 of a placed order may be changed.

The trading device may generate the pricing path order indicia 420c from the market data by identifying a price 404 of child order over a period of time. The trading device may identify the price 404 and the time interval 406 at which each child order is placed and may indicate the path of the child over one or more intervals 406 until the child order is filled. The trading device may overlay the pricing path order indicia 420c on the image of the bar graph 402 in a location that indicates the price 404 of one or more child orders from the time interval 406 at which the child order was placed to the time interval 406 at which the child order was filled.

The placed child orders may change in price in an attempt to get filled as the market moves away from the price at which the child orders are resting in the market. For example, the price of a child order may change when the best bid or the best offer of a price bar exceeds a threshold price difference from the price of the resting child order. In certain embodiments, the price of a child order may be changed when an existing resting order is working in the market and the slicer parent order places a new child order at a different price than the resting child order (e.g., the new child order may be placed as a market order and/or at the current best bid). In certain embodiments, the price of a child order may be changed after a certain number of slicer intervals have been completed based on market conditions (e.g., changes to the inside market) and user-specified offset (e.g., a 3 tick range from the specified price, or a 15% variation from the specified price). The pricing path order indicia 420c may show the pricing path of a child order as it changes in price according to changes in the market in an attempt to get filled. In certain embodiments, the trading device may identify changes in resting orders in the market data and may change the price of a resting child order by the same amount as orders of the market data that change during the time intervals 406.

The trading device may generate changed price order indicia 420d to indicate changes in the price 404 of the placed child orders based on the changes in the market data displayed in the bar graph 402. The trading device may overlay a changed price order indicator 420d at a location on the image of the bar graph 402 that identifies the time interval 406 at which the price of a child order was changed and/or the actual change in the price 404. Though the changed price order indicia 420d show the price 404 to which the child orders may be changed, the trading device may also, or alternatively, display the changed price order indicia 420d at a location from which the child orders may be changed. If the price 404 of a child order does not change from the time the child order is placed, the trading device may display the pricing path order indicia 420c from the place order indicator 420a of the child order over the time intervals 406 for which the child order is resting (e.g., to the fill order indicia 420b for the child order when the child order has been filled).

The trading device may display the order indicia 420a, 420b, 420c, 420d according to order indicia configuration information 422. The order indicia configuration information 422 may be set to display one or more order indicia 420a, 420b, 420c, and 420d by default. The trading device may receive an indication from a user to display one or more order indicia 420a, 420b, 420c, 420d by selection of a corresponding button (e.g., check boxes and/or radio button) for each type of order indicia 420a, 420b, 420c, 420d. The buttons for configuring the order indicia configuration information 422 may be displayed in the slicer information input box 410 or elsewhere within the user interface 400 or another interface. The settings for the order indicia configuration information 422 may be stored at the trading device.

The order indicia 420a, 420b, 420c, 420d may be displayed to provide slicer order information to users. The trading device may also, or alternatively, generate slicer performance information 424, as shown in FIGS. 4B and 4C, which may be displayed to indicate the performance of order parameters for slicer orders applied to market data. The slicer performance information 424 may also be overlaid on the image of the bar graph 402, but the slicer performance information 424 may be displayed elsewhere on the interface 400 or in another interface. The slicer performance information 424 may be generated from the stored time intervals 406 and/or prices 404 at which the child orders may be filled in the market. For example, the trading device may calculate the average fill price for each of the child orders in a parent slicer order and may provide the average fill price in the slicer performance information 424. The average fill price may be updated as child orders are filled, or may be calculated when the parent slicer order is fully filled. The trading device may calculate the amount of time to fully fill the slicer order quantity 416 and may provide the full fill time in the slicer performance information 424. The full fill time may be calculated from the start time 412 to the time interval 406 (e.g., end of the time interval 406) at which the last child order of a parent slicer order is filled. If the parent slicer order is not fully filled, the full fill time may display a null value. If the parent slicer order is applied to historical market data and is not fully filled, the full fill time may display a null value or another notification to the user to indicate that the parameters in the slicer information was unable to provide a fill in the market data during the time intervals 406.

The user may adjust slicer orders in response to the slicer order information (e.g., order indicia 420a, 420b, 420c, 420d) and/or the slicer performance information. For example, the user may adjust the parameters in the slicer order information and select the button 418 to apply the updated order parameters to the market data displayed in the bar graph 402. The updated parameters may be used to execute another order on the market or to update an order currently pending in the market (e.g., a slicer order resting at an electronic exchange). The user may adjust the order parameters to attempt to improve the performance of the slicer order (e.g., get a better average fill price and/or a quicker fill time for the slicer order).

The trading device may identify adjustments to the order parameters by the changes to the parameters in the slicer information input box 410 or by user selections on the image of the bar graph 402. For example, the user may adjust the start time 412 by selecting the order indicator 420a that represents the first child order of a parent slicer order and moving the order indicator 420a to another time interval 406. The user may similarly adjust the time interval 414b for a time slicer order by selecting one of the order indicia 420a that represent child orders other than the first child order and moving the order indicia 420a, 420b to another time interval 406. The user may also adjust the number of intervals 406 and the market data displayed in the bar graph 402 (e.g., by zooming in or out on the bar graph 402). The trading device may automatically update the location of the order indicia 420a, 420b on the image of the bar graph 402 to reflect the placement of orders and fills of orders in the market based on the adjustments. The trading device may also update the slicer performance information 424 according to the adjustments.

By adjusting the order parameters of the slicer orders, the interface 400 may provide slicer order information and/or slicer performance information that may assist a user in deciding the proper selection of order parameters for a slicer order, such as the proper volume intervals 414a, time intervals 414b, order quantities 416, and/or start time 412 (e.g., time of day), to obtain better order performance for a slicer order. The interface 400 may be generated at one or more trading devices for being displayed. For example, the interfaces 400 may be generated and displayed locally on a trading device, or may be generated at a trading device for being displayed remotely on another device (e.g., via a remote application or web interface). In an example, the interface 400 may be generated by a trading application that may be executed on a trading server for being displayed on a trading terminal, or the interface 400 may be generated locally at the trading terminal for being displayed to a user.

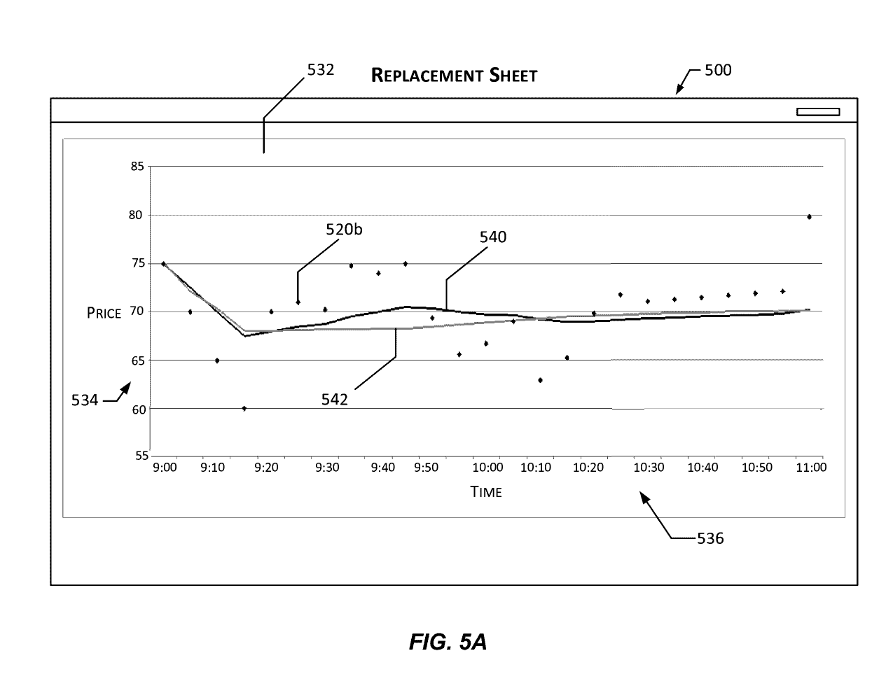

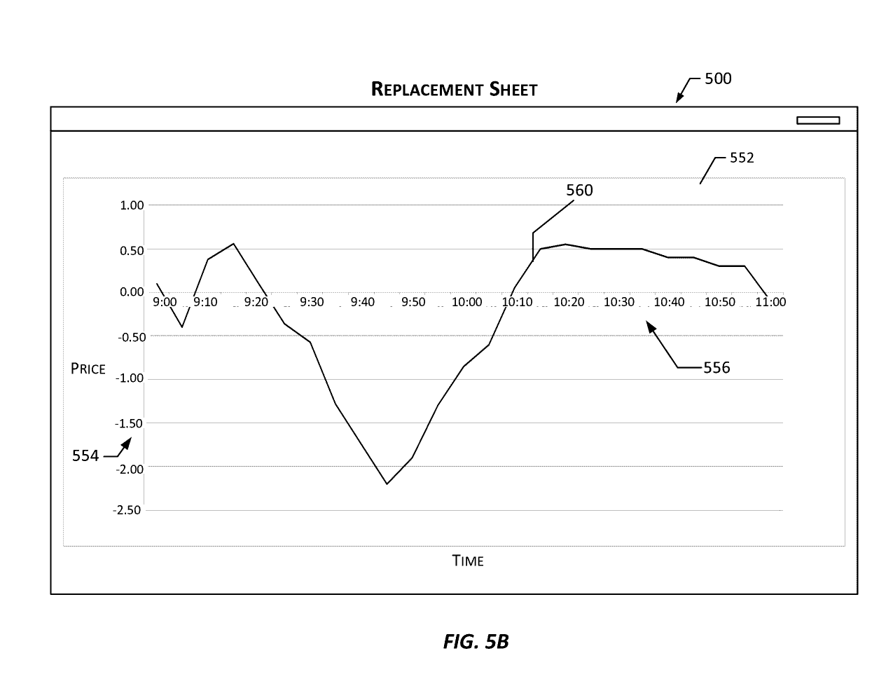

The trading device may also, or alternatively, generate other slicer performance information that may assist users in deciding the proper selection of order parameters for a slicer order. The other slicer performance information may be displayed in the user interface 400 (e.g., overlaid on the image of the bar graph 402) or another interface, for example. FIGS. 5A-5C show examples of different slicer performance information that may be generated at a trading device and displayed in a user interface.

FIG. 5A, illustrates an example of a graph 532 that may be generated and/or displayed at a trading device to indicate the performance of slicer orders that may be applied to market data (e.g., historical or real-time market data) by the trading device. In particular, FIG. 5A illustrates an example of slicer performance information depicting a traded average with respect to a benchmark for a single day. In operation, the trading device may generate the graph 532 from market data, such as the market data from which a bar graph may be generated, for example. The graph 532 may include fill order indicia 520b that may indicate a price 534 and a time interval 536 at which child orders may be filled in a market. The fill order indicia 520b may be overlaid on the image of the graph 532 in a location that indicates the price 534 for each fill of a child order (or the average fill of multiple slicer orders) in a respective time interval 536.

The trading device may calculate the realized weighted average price 540 of the child orders and may overlay the realized weighted average price 540 as a line on the graph 532. The realized weighted average price 540 may be calculated by weighting the average prices according to the quantity of the child orders filled at each price. The graph 532 may also include a volume-weighted average price 542, which may be calculated by the trading device. The trading device may calculate the volume-weighted average price 542 by averaging the price of the orders filled in the market data and weighting the average prices according to the quantity of the orders filled at each price.

The trading device may overlay an indicator of the volume-weighted average price 542 of the trade orders in the market on the image of the graph 532, such that the realized weighted average price 540 of the parent slicer order may be compared against the volume-weighted average price 542 of the market. The volume-weighted average price 542 may be used as a benchmark against which the realized weighted average price 540 may be compared. When the realized weighted average price 540 is above the volume-weighted average price 542, the realized weighted average price 540 for sell orders may be performing better than the market for sell orders. The user may change the order parameters of a slicer order in an attempt to maintain the realized-weighted average price 540 above the volume-weighted average price for longer periods of time.

FIG. 5B illustrates another example of a graph 552 that may be generated and/or displayed at a trading device to indicate the performance of slicer orders that may be applied to market data (e.g., historical or real-time market data) by the trading device. In particular, FIG. 5B illustrates an example of slicer performance information depicting a normalized view of the traded average. The trading device may generate the graph 552 by calculating the difference between the volume-weighted average price 542 and the realized weighted average price 540 shown in FIG. 5A. The graph 552 may include an indicator 560 that illustrates the change in the relative price 554 for the realized weighted average price 540 when compared to the volume-weighted average price 542 over the time intervals 556. The volume-weighted average price 542 (shown in FIG. 5A) may be utilized as the zero value of the graph 552. The graph 552 may be generated at the trading device by calculating the difference in the price 554 for the volume-weighted average price 542 and the realized weighted average price 540 at each time interval 536 and displaying the difference of each calculated price value as the relative price 554 for each interval 556.

The trading device may overlay the order indicia 420a, 420b, 420c, 420d (shown in FIGS. 4A-4C) related to the child orders on the graphs 502, 532, 552 in FIGS. 5A-5C to indicate the prices and times at which child orders may be placed, filled, and/or changed. The trading device may identify the good fills and/or the bad fills by identifying the order indicia 420b that are above and/or below the benchmark (e.g., the volume-weighted average price), respectively.

The trading device may place each of the child orders at the best bid or best offer price and may rest the order in the market (e.g., in the simulated or actual market) until identifying a match for the order or until the market (e.g., best bid or best offer) increases or decreases to a predefined change order threshold. The change order threshold may be a predefined range of prices above or below the child order price before the child order price may change to be filled. The slicer information may include an order parameter for the parent slicer order that may identify the change order threshold. For example, a change order threshold may be established halfway through each slice interval and may result in the repricing of any resting child order. In certain embodiments, when the change order threshold is exceeded in the market data, the trading device may change the child order price to the best bid or best offer price identified in the market data (e.g., in the same time interval).

The predefined change order threshold may be set to prevent a user from giving up edge in the market. The predefined change order threshold may allow a child order to rest in the market while the market may fluctuate up and down within the predefined range to allow for better chance of receiving a fill at the child order price.

As shown in FIG. 5C, a trading device may display the performance of slicer orders that may be executed by the trading device over different periods of time 508. For example, FIG. 5C shows the performance of slicer orders 510 that may be applied to market data (e.g., historical or real-time market data) by a trading device over a number of days, though any number of different periods of time 508. The trading device may generate the graph 502 from the stored prices and time intervals at which slicer orders may be placed and filled according to defined order parameters. The graph 502 displays a line graph for different slicer orders 510 over different periods of time 508. Each of the slicer orders 510 may be applied to the same market data using different defined order parameters, for example.

The graph 502 identifies the difference in relative price 504 at which the child orders of the parent slicer orders 510 may be matched over the time intervals 506 during the different periods of time 508. The trading device may calculate the relative price 504 of each of the slicer orders 510 from a base price or benchmark, which may be displayed as the relative price 504 having the value of zero.

If the parent slicer order 510 is a volume-based slicer order, then the benchmark may be the volume-weighted average price of the market data to which the parent slicer order(s) 510 are applied. If the parent slicer order 510 is a time-based slicer order, then the benchmark may be the time-weighted average price of the market data to which the parent slicer order(s) 510 are applied. For example, the trading device may calculate the volume-weighted average price of the market data by summing the quotient of each trade's price at quantity, then dividing by the cumulative quantity for all trades. In certain embodiments, the trading device may calculate the time-weighted average price of the market data by summing the average of the open, high, low, and close prices for each bar divided total number of bar. The trading device may set the value of the volume-weighted average price as zero in the graph 502 to identify a benchmark against which the slicer orders 510 may be compared. In practice, utilizing the value of the volume-weighted average price as zero in the graph 502, serves to normalize price fluctuations and highlight variation(s) from benchmark over a time period of interest. The trading device may calculate the difference between the volume-weighted average price of the market at each interval and the child order price at each interval 506 for the slicer orders 510 and may display the difference for each of the slicer orders 510 in the graph 502.

The graph 502 depicts an absolute-value comparison in the performance of different slicer orders 510 over the same time intervals 506 to assist a user in identifying order parameters that may be adjusted to change the performance of the slicer orders. In practice, the absolute value comparison illustrates that the higher the relative price 504 of the slicer orders 510, the better the performance of the defined parameters when applied to the market data and, the lower the relative price 504 of the slicer orders 510, the worse the performance of the defined parameters when applied to the market data. The trading device may overlay the order indicia 420a, 420b, 420c, 420d (shown in FIGS. 4A-4C) related to the child orders for each of the time periods 508 to show the relative prices 504 and time intervals 506 at which child orders may be placed, filled, and/or changed.

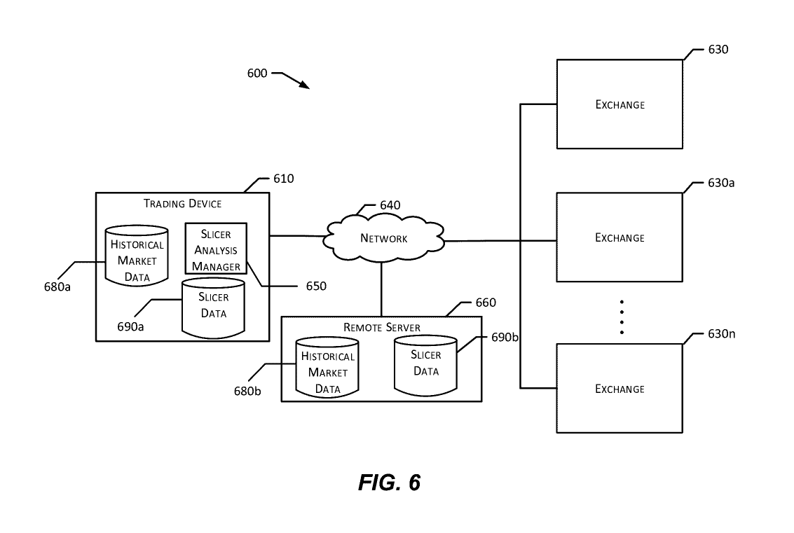

FIG. 6 illustrates a block diagram of an example system 600 that may be used to generate and display slicer order information and/or slicer performance information at a trading device 610. The system 600 includes a trading device 610 that may receive market data from one or more exchanges, such as exchange 630 and/or exchanges 630a to 630n. The market data may correspond to one or more tradeable objects at each market. The trading device 610 may communicate with the exchanges directly or through a network 640.

The trading device 610 may be capable of generating and displaying user interfaces that include slicer order information and/or slicer performance information as described herein. The trading device 610 may be a trading server and/or a trading terminal. The functionality described herein may be performed on the trading terminal, the trading server, or distributed across the trading terminal and the trading server. For example, the trading device 610 may include a trading terminal capable of displaying a user interface for an application executing locally on the trading terminal or an application executing remotely on the trading server (e.g., via a web browser or other application).

The trading device 610 may include a slicer analysis manager 650, which may be executed locally at the trading terminal, at the trading server, or distributed across the trading terminal and the trading server. The slicer analysis manager 650 may be executed as software and/or hardware. For example, the slicer analysis manager 650 may be a software module included in a trading application that is executed by a processor from memory at the trading device 610, or an independent hardware module.

The slicer analysis manager 650 may analyze market data to generate and display slicer order information and/or slicer performance information. The market data may include historical market data 680a, which may be stored in memory in a datastore at the trading device 610. The market data may include historical market data 680b which may be stored in memory in a datastore at a remote server 660. The trading device may communicate with the remote server 660 directly or via the network 640. The market data may include real-time market data and/or historical market data received from one or more exchanges, such as exchange 630 and/or exchanges 630a to 630n. The slicer order information and/or the slicer performance information may be generated relative to historical market data to simulate slicer orders, or relative to real-time market data.

The slicer analysis manager 650 may store slicer data 690a in memory at the trading device 610. The slicer analysis manager may also, or alternatively, store slicer data 690b in memory at the remote server 660. The slicer data 690a, 690b may include the slicer order information and/or the slicer performance information that may be generated when the slicer order information is applied to market data. The slicer order information may include order indicia that may be generated and displayed at the trading device 610. The slicer order information may also, or alternatively, include the prices and times at which slicer orders (e.g., child orders) may be placed, filled, and/or changed. The slicer analysis manager 650 may submit queries to the remote server 660 for historical market data 680b and/or slicer data 690b.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed:

1. A method comprising:
receiving, at a slicer analysis manager, market data related to at least one tradeable object from an electronic exchange;
displaying, via the slicer analysis manager, the market data in an image;
receiving, at the slicer analysis manager, slicer information, wherein the slicer information comprises a start time to begin slicing a parent slicer order for being matched within the market data, at least one interval at which the parent slicer order is sliced into a plurality of child orders for being matched within the market data, and an order quantity associated with the parent slicer order;
defining, via the slicer analysis manager, the parent slicer order based on the received slicer information;
applying, via the slicer analysis manager, the parent slicer order to the market data according to the received slicer information, wherein the parent slicer order is applied by identifying in the market data a time and a price at which each of the plurality of child orders is placed and filled;
generating, via the slicer analysis manager, order indicia relative to the displayed market data;
overlaying, via the slicer analysis manager, the order indicia on the image of the displayed market data, wherein the order indicia indicate at least one of the time or the price at which each of the plurality of child orders was placed when applied to the market data; and
generating, via the slicer analysis manager, slicer performance information that indicates a performance of the defined parent slicer when applied to the market data.

2. The method of claim 1, wherein the at least one interval comprises a time interval.

3. The method of claim 1, wherein the at least one interval comprises a volume interval.

4. The method of claim 1, wherein the slicer information is received by user selection of a location in the image.

5. The method of claim 1, wherein the market data comprises historical market data that is retrieved from a historical market datastore.

6. The method of claim 1, further comprising:
displaying, via the slicer analysis manager, the slicer performance information in a graph.

7. The method of claim 1, wherein the slicer performance information comprises at least one of an average fill price for each of the plurality of child orders or an amount of time until the order quantity associated with the parent slicer order is fully filled in the market data.

8. The method of claim 1, wherein the order indicia indicate at least one of a time or a price at which each of the plurality of child orders was filled when applied to the market data.

9. The method of claim 1, wherein the order indicia indicate at least one of a time or a price at which each of the plurality of child orders was changed when applied to the market data.

10. The method of claim 1, wherein the order indicia indicate a pricing path that shows the price of the child orders over one or more time intervals.

11. A method comprising:
receiving, at a slicer analysis manager, market data related to at least one tradeable object from an electronic exchange;
displaying, via the slicer analysis manager, the market data in an image;
receiving, at the slicer analysis manager, slicer information, wherein the slicer information comprises a start time to begin slicing a parent slicer order for being matched within the market data, at least one interval at which the parent slicer order is sliced into a plurality of child orders for being matched within the market data, and an order quantity associated with the parent slicer order; and
generating, via the slicer analysis manager, order indicia relative to the displayed market data, wherein the order indicia indicate a time and a price at which each of the plurality of child orders was placed in the market data.

12. The method of claim 11, further comprising:
defining, via the slicer analysis manager, the parent slicer order based on the received slicer information;
applying, via the slicer analysis manager, the parent slicer order to the market data according to the received slicer information, wherein the parent slicer order is applied by identifying in the market data a time and a price at which each of the plurality of child orders is placed and filled; and
overlaying, via the slicer analysis manager, the order indicia on the image of the displayed market data, wherein the order indicia indicate at least one of the time or the price at which each of the plurality of child orders was placed in the market data.

13. The method of claim 12, further comprising generating, via the slicer analysis manager, slicer performance information that indicates a performance of the defined parent slicer when applied to the market data.

14. The method of claim 12, wherein the order indicia indicate at least one of a time or a price at which each of the plurality of child orders was filled when applied to the market data.

15. The method of claim 12, wherein the order indicia indicate at least one of a time or a price at which each of the plurality of child orders was changed when applied to the market data.

16. The method of claim 11, wherein the at least one interval comprises a time interval.

17. The method of claim 11, wherein the at least one interval comprises a volume interval.

18. The method of claim 11, wherein the slicer information is received by user selection of a location in the image.

19. The method of claim 11, wherein the market data comprises historical market data.

20. The method of claim 11, wherein the slicer analysis manager is executed by a processor at a trading device.
